(19) United States
(12) Patent Application Publication
(10) Pub. No.: US 2024/0208876 A1
(43) Pub. Date: Jun. 27, 2024

(54) COMPONENTS HAVING SINTERING AID-FREE COATING SYSTEMS THEREON AND METHODS FOR PRODUCING THE SAME

(71) Applicant: HONEYWELL INTERNATIONAL INC., Charlotte, NC (US)

(72) Inventors: John Downs, Morris Plains, NJ (US); Kevin S. Blinn, Morris Plains, NJ (US); Bahram Jadidian, Morris Plains, NJ (US); Mehrad Mehr, Morris Plains, NJ (US)

(73) Assignee: HONEYWELL INTERNATIONAL INC., Charlotte, NC (US)

(21) Appl. No.: 18/146,545

(22) Filed: Dec. 27, 2022

(51) Int. Cl. C04B 41/50; C04B 41/00; C04B 41/45; C04B 41/52; C04B 41/89

(52) U.S. Cl. CPC C04B 41/5024; C04B 41/0072; C04B 41/009; C04B 41/4539; C04B 41/52; C04B 41/89

(57) ABSTRACT

Components and methods for producing such components are provided. The component comprises a substrate having a ceramic material, and a coating system on a surface of the substrate. The coating system includes one or more layers defining a composition gradient. A first portion of the coating system closest to the surface of the substrate has a composition comprising at least 95 wt. % of a rare earth disilicate, a second portion of the coating system furthest from the surface of the substrate has a composition comprising at least 50 wt. % of a rare earth monosilicate, and a third portion between the first portion and the second portion has a composition comprising both the rare earth disilicate and the rare earth monosilicate.

### STATEMENT REGARDING FEDERALLY SPONSORED RESEARCH OR DEVELOPMENT

This invention was made with Government support under FA8650-15-D-2504 TOA FA8650-17-F-2001 awarded by Air Force Research Laboratory. The Government has certain rights in this invention.

### TECHNICAL FIELD

The present invention generally relates to coating systems for high temperature components, and more particularly relates to sintering-aid free coating system for components capable for use at temperatures of 2850° F. (about 1565° C.) or greater.

### BACKGROUND

Ceramic materials are currently being employed for high temperature components of gas turbine engines such as, for instance, airfoils (e.g., blades and vanes), combustor liners, and shrouds. Although ceramic materials exhibit desirable high temperature characteristics, exposed surfaces tend to erode in combustion environments due to air or steam rapidly passing over wherein water vapor becomes a reactive species and causes erosion. In order to minimize this erosion, environmental barrier coatings (EBCs) can be applied to the exposed surfaces of the ceramic materials which can serve as a barrier between the combustion gases and the ceramic materials. However, modern engine cycles may exceed the temperature capabilities of EBCs which can result in spallation of the EBC.

Hence, there is a need for coating systems for high temperature components capable of providing environmental and thermal protection at high temperatures, such as 2850° F. (about 1565° C.) or greater. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A component is provided that includes a sintering aid-free coating system. The component comprises a substrate having a ceramic material, and a coating system on a surface of the substrate. The coating system includes one or more layers defining a composition gradient. A first portion of the coating system closest to the surface of the substrate has a composition comprising at least 95 wt. % of a rare earth disilicate, a second portion of the coating system furthest from the surface of the substrate has a composition comprising at least 50 wt. % of a rare earth monosilicate, and a third portion between the first portion and the second portion has a composition comprising both the rare earth disilicate and the rare earth monosilicate.

A method is provided for producing a component having a coating system thereon. The method comprises providing a substrate having a ceramic material, and forming one or more layers on the substrate to define the coating system. The one or more layers define a composition gradient. A first portion of the coating system closest to the surface of the substrate has a composition comprising at least 95 wt. % of a rare earth disilicate, a second portion of the coating system furthest from the surface of the substrate has a composition comprising at least 50 wt. % of a rare earth monosilicate, and a third portion between the first portion and the second portion has a composition comprising both the rare earth disilicate and the rare earth monosilicate. The coating system is formed without using a sintering aid.

Furthermore, other desirable features and characteristics of the component and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a schematic view of a gas turbine engine according to example embodiments of the present disclosure;

FIG. 2 is a schematic cross section of a coated outer surface of a component of the gas turbine engine according to example embodiments of the present disclosure;

FIG. 3 is a flow chart illustrating a method for producing a coating system on a substrate according to example embodiments of the present disclosure;

FIG. 4 is an image of a cross-sectional view of a coated outer surface of a component of a gas turbine engine according to example embodiments of the present disclosure;

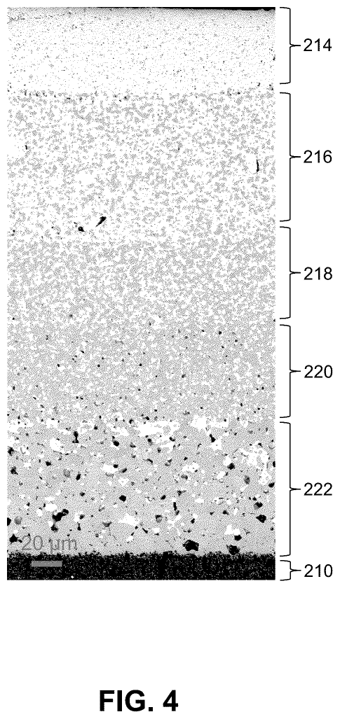

FIG. 5 is an image of a cross-sectional view of an environmental barrier coating applied to a substrate according to example embodiments of the present disclosure; and

FIG. 6 is an image of a cross-sectional view of outermost layers of a thermal barrier coating according to example embodiments of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Broadly, embodiments of the present disclosure include high temperature components that have an improved coating system bonded to a substrate thereof. The present disclosure also includes manufacturing methods for providing the high temperature components. The coating systems may be capable of providing environmental and thermal protection at high temperatures, such as 2850° F. (about 1565° C.) or greater.

In various embodiments, the components may be any portion of a vehicle, aircraft, ship, train, etc. In another embodiment, the components may be any portion of an aerospace vehicle, engine, or application. Alternatively, the components may be any portion of an engine, e.g., a gas turbine engine, such as an aircraft engine. Non-limiting examples of such components include airfoils (e.g., blades and vanes), combustor liners, and shrouds. Alternatively, the components may be any portion of an engine for a vehicle, ship, train, etc. Alternatively, the components may be used in any industry including, but not limited to, the automobile industry, the aerospace industry, transportation industry, etc. Even further, the components may be an article used in any high temperature and/or pressure environment including, but not limited to, power plants, mining, petroleum and oil refining, fracking, under water applications, deep sea applications, etc. In one embodiment, the component is a gas turbine engine component. In another embodiment, the component is a monolithic shroud.

The coating system may include a plurality of layers, such as an environmental barrier coating (EBC) having one or more layers, and a thermal barrier coating (TBC) having one or more layers. The EBC may be provided on an underlying surface, such as that of a substrate or another coating thereon, and the TBC may be provided on the EBC.

Typically, EBCs for use with high temperature ceramic components include a glass phase sintering aid. However, sintering aids may wick into upper portions of the TBC. During engine operation, any sintering aid present within the TBC may remelt and cause bubbling of the TBC. Notably, the EBCs disclosed herein are formed without the use of sintering aids. As such, the coating systems are capable of providing improved thermal and environmental protection relative to various prior art coating systems, especially at temperatures in excess of 2850° F. (about 1565° C.).

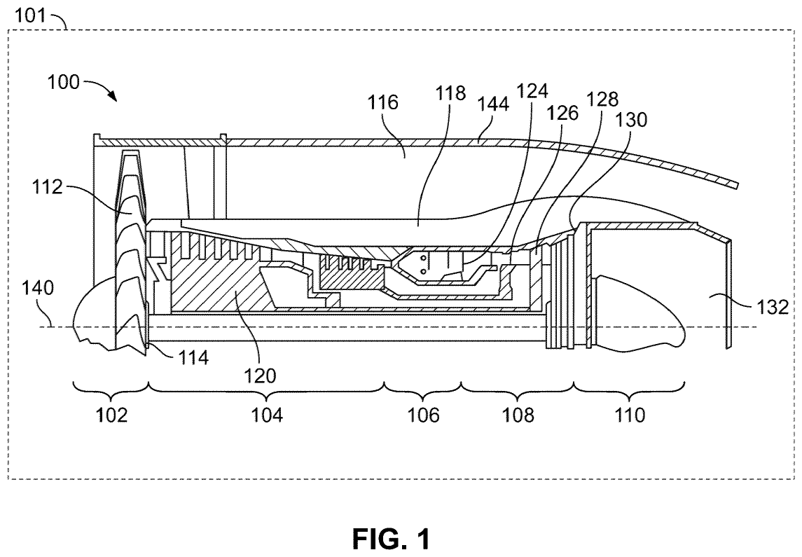

With reference to FIG. 1, a partial, cross-sectional view of an exemplary gas turbine engine 100 is shown with the remaining portion of the gas turbine engine 100 being substantially axisymmetric about a longitudinal axis 140, which also defines an axis of rotation for the gas turbine engine 100. In the depicted embodiment, the gas turbine engine 100 is an annular multi-spool turbofan gas turbine jet engine within an aircraft (represented schematically at 101), although features of the present disclosure may be included in other configurations, arrangements, and/or uses. For example, in other embodiments, the gas turbine engine 100 may assume the form of a non-propulsive engine, such as an Auxiliary Power Unit (APU) deployed onboard the aircraft 101, an industrial power generator, or other turbomachine.

In this example, with continued reference to FIG. 1, the gas turbine engine 100 includes a fan section 102, a compressor section 104, a combustor section 106, a turbine section 108, and an exhaust section 110. In one example, the fan section 102 includes a fan 112 mounted on a rotor 114 that draws air into the gas turbine engine 100 and compresses it. A fraction of the compressed air exhausted from the fan 112 is directed through the outer bypass duct 116 and the remaining fraction of air exhausted from the fan 112 is directed into the compressor section 104. The outer bypass duct 116 is generally defined by an outer casing 144 that is spaced apart from and surrounds an inner bypass duct 118.

In the embodiment of FIG. 1, the compressor section 104 includes one or more compressors 120. The number of compressors 120 in the compressor section 104 and the configuration thereof may vary. The one or more compressors 120 sequentially raise the pressure of the air and direct a majority of the high-pressure fluid or air into the combustor section 106. In the combustor section 106, which includes a combustion chamber 124, the high-pressure air is mixed with fuel and is combusted. The high-temperature combustion air or combustive gas flow is directed into the turbine section 108. In this example, the turbine section 108 includes three turbines disposed in axial flow series, namely, a high-pressure turbine 126, an intermediate pressure turbine 128, and a low-pressure turbine 130. However, it will be appreciated that the number of turbines, and/or the configurations thereof, may vary. In this embodiment, the high-temperature combusted air from the combustor section 106 expands through and rotates each turbine 126, 128, and 130. The combustive gas flow then exits the turbine section 108 for mixture with the cooler bypass airflow from the outer bypass duct 116 and is ultimately discharged from the gas turbine engine 100 through the exhaust section 132. As the turbines 126, 128, 130 rotate, each drives equipment in the gas turbine engine 100 via concentrically disposed shafts or spools.

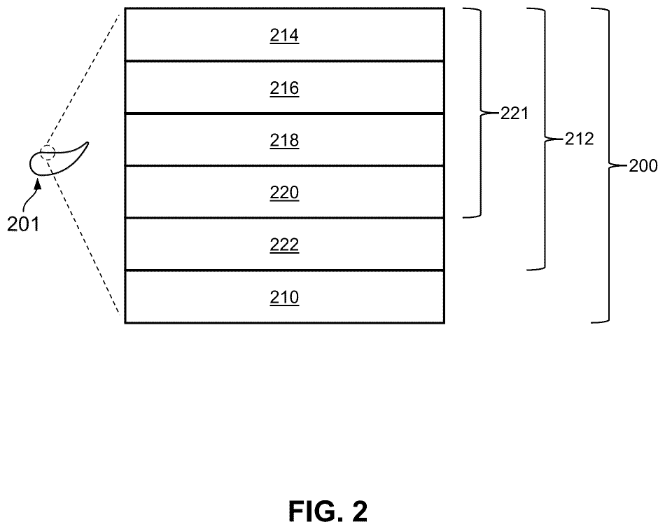

The engine 100 may include at least one component 201 with a coated outer surface 200, such as the airfoil-shaped component 201 shown in FIG. 2. The component 201 may be included in an area of the engine 100 subjected to high-temperature environments. Thus, the component 201 may be included in the combustor section 106, the turbine section 108, etc. In various embodiments, a blade, vane, shroud, combustor liner, or other component of the engine 100 may include the coated outer surface 200. It will be appreciated that the coated outer surface 200 may be included on a component of something other than a gas turbine engine 100 without departing from the scope of the present disclosure. The coated outer surface 200 may generally include a substrate 210 and the coating system 212.

The substrate 210 may define a majority of the component 201 and may have a variety of shapes without departing from the scope of the present disclosure. For example, as represented in FIG. 2, the substrate 210 may be airfoil-shaped. The substrate 210 may be constructed of a ceramic material. The substrate 210 may include or be a monolithic ceramic or a ceramic matrix composite. A ceramic is an inorganic solid that may include metals, non-metals, or metalloid atoms primarily held together with ionic and/or covalent bonds. Ceramics may be crystalline, semi-crystalline, partially crystalline, or amorphous. The substrate 210 may include ceramic material throughout, such that the substrate 210 is essentially 100 percent ceramic. Alternatively, the substrate 210 may be defined as a substrate that includes a ceramic coating disposed over a non-ceramic (e.g., metallic) core. The substrate 210 is not particularly limited in size, dimensions, etc.

The substrate 210 may be or include any ceramic known in the art. For example, the substrate 210 may be or include silicon nitride, silicon carbide, silicon-carbide-silicon carbide composites, silicon oxynitride, SiAlON materials (materials that include silicon, aluminum, oxygen, and nitrogen), silicon dioxide, and combinations thereof. In other embodiments, the substrate 210 may be or include silicon nitride, silicon carbide, silicon-carbide-silicon carbide composites, or combinations thereof. In various embodiments, the substrate 210 may be or include from about 50 to about 100 weight percent, or from about 80 to about 100 weight percent, or from about 99 to about 100 weight percent of silicon nitride, silicon carbide, silicon oxynitride, SiAlON materials, silicon dioxide, and combinations thereof. In various non-limiting embodiments, all values and ranges of values including and between those set forth above are hereby expressly contemplated for use herein.

The coating system 212 includes an environmental barrier coating (EBC) 222 disposed on a surface of the substrate 210. The EBC 222 may serve as a barrier between the substrate 210 and high temperature air or steam when operating in conditions wherein water vapor becomes a reactive species and causes erosion. Although represented as a single layer, the EBC 222 may include more than one layer. The EBC 222 may be disposed on and in direct contact with the substrate 210. In other words, there may be no intervening layer disposed between the EBC 222 and the substrate 210. For example, there may be no oxide layer and/or silica layer disposed between the EBC 222 and the substrate 210. Alternatively, the EBC 222 may be deposited on another coating on the substrate 210.

The coating system 212 includes a thermal barrier coating (TBC) 221 disposed on a surface of the EBC 222. The TBC 221 may have low thermal conductivity for thermally protecting the underlying EBC 222 and the substrate 210. The TBC 221 may include one or more layers. In this embodiment, the TBC 221 is represented as including four layers including a first layer 220 (i.e., innermost layer of the TBC 221) on the EBC 222, a second layer 218 on the first layer 220, a third layer 216 on the second layer 218, and a fourth layer 214 (i.e., outermost layer of the TBC 221) on the third layer 216.

The EBC 222 and the TBC 221 may be any known in the art. For example, the EBC 222 and/or the TBC 221 may include a rare earth silicate that may be or include at least one rare earth monosilicate (e.g., RE₂SiO₅, where RE is a rare earth element), at least one rare earth disilicate (e.g., RE₂Si₂O₇, where RE is a rare earth element), or combinations thereof. The rare earth element may include at least one of Lu (lutetium), Yb (ytterbium), Tm (thulium), Er (erbium), Ho (holmium), Dy (dysprosium), Tb (terbium), Gd (gadolinium), Eu (europium), Sm (samarium), Pm (promethium), Nd (neodymium), Pr (praseodymium), Ce (cerium), La (lanthanum), Y (yttrium), or Sc (scandium). In various embodiments, the rare earth silicate is Y₂SiO₅, Gd₂SiO₅, Er₂SiO₅, Yb₂SiO₅, or Lu₂SiO₅, Y₂Si₂O₇, Gd₂Si₂O₇, Er₂Si₂O₇, Yb₂Si₂O₇, or Lu₂Si₂O₇, or combinations thereof.

In various embodiments, the EBC 222 includes a composition that is entirely or predominately a first material and the layers 220, 218, 216, and 214 of the TBC 221 define a composition gradient that transitions from a first composition (e.g., in the first layer 220) that is predominately the first material of the EBC 222 to a second composition (e.g., in the fourth layer 214) that is entirely, predominately, or a majority of a second material. For example, the EBC 222 may include a composition that is entirely or predominately a rare earth disilicate and the layers 220, 218, 216, and 214 of the TBC 221 may define a composition gradient that transitions from a first composition (e.g., in the first layer 220) that is predominately the rare earth disilicate of the EBC 222 to a second composition (e.g., in the fourth layer 214) that is entirely or predominately a rare earth monosilicate.

In a specific but nonlimiting example, the EBC 222 consists essentially of ytterbium disilicate, that is, has a composition of at least 95 wt. %, such as substantially 100 wt. %, ytterbium disilicate, and the first, second, third, and fourth layers 220, 218, 216, and 214 of the TBC 221 provide a composition gradient that transitions from predominately ytterbium disilicate to predominately ytterbium monosilicate. In this manner, the TBC 221 is capable of providing thermal protection with the low thermal conductivity of ytterbium monosilicate while accommodating for the difference in the coefficient of thermal expansion (CTE) between the ytterbium disilicate in the EBC 222 and the ytterbium monosilicate in the TBC 221.

In such embodiments, each of the layers 218, 216, and 214 of the TBC 221 have a reduced concentration of the first material (e.g., ytterbium disilicate) and an increased concentration of the second material (e.g., ytterbium monosilicate) relative to the underlying layers. In the above noted example, the concentration of the first material may be reduced by about 5 to 50 wt. % per layer 220, 218, 216, and 214 of the TBC 221 and the second material may be increased by about 5 to 50 wt. % per layer 220, 218, 216, 214 of the TBC 221. For example, the first layer 220 of the TBC 221 may have a composition comprising about 20 to 30 wt. %, such as about 25 wt. %, of a rare earth monosilicate and about 70 to 80 wt. %, such as about 75 wt. %, of a rare earth disilicate, the second layer 218 of the TBC 221 may have a composition comprising about 45 to 55 wt. %, such as about 50 wt. %, of the rare earth monosilicate and about 45 to 55 wt. %, such as about 50 wt. % of the rare earth disilicate, the third layer 216 of the TBC 221 may have a composition comprising about 70 to 80 wt. %, such as about 75 wt. % of the rare earth monosilicate and about 20 to 30 wt. %, such as about 25 wt. % of the rare earth disilicate, and the fourth layer 214 of the TBC 221 may have a composition comprising at least 50 wt. %, at least 60 wt. %, at least 70 wt. %, at least 80 wt. %, at least 90 wt. %, at least 95 wt. %, or substantially 100 wt. % of the rare earth monosilicate with the remainder, if any, being the rare earth disilicate.

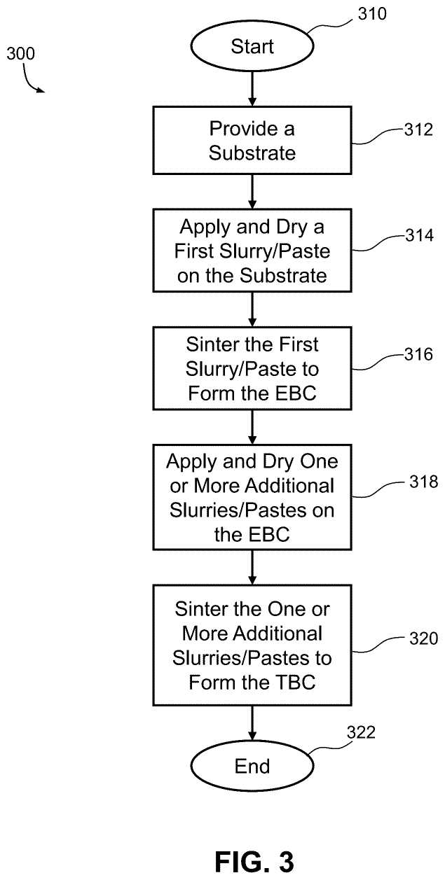

FIG. 3 shows a nonlimiting example of the coating system 212 on the substrate 210 wherein the EBC 222 includes about 100 wt. %, ytterbium disilicate, the first layer 220 of the TBC 221 includes about 25 wt. % ytterbium monosilicate and about 75 wt. % ytterbium disilicate, the second layer 218 of the TBC 221 includes about 50 wt. % ytterbium monosilicate and about 50 wt. % ytterbium disilicate, the third layer 216 of the TBC 221 includes about 75 wt. % ytterbium monosilicate and 25 wt. % ytterbium disilicate, and the fourth layer 214 of the TBC 221 includes about 100 wt. % ytterbium monosilicate.

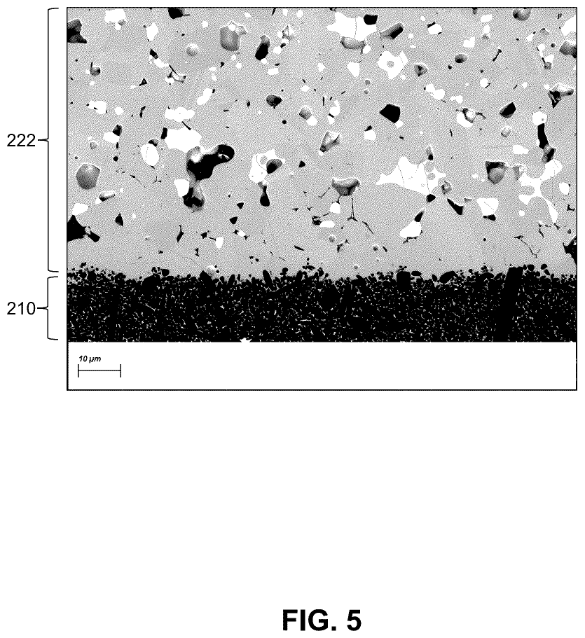

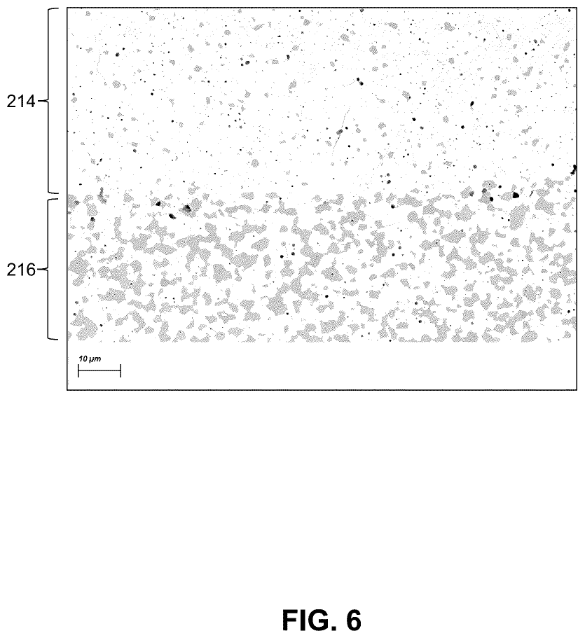

In various embodiments, the EBC 222 and the TBC 221 may consist of the first and/or second materials, such as a rare earth disilicate and/or a rare earth monosilicate (e.g., ytterbium disilicate and/or ytterbium monosilicate). Alternatively, one or more of the layers 222, 220, 218, 216, and 214 of the coating system 212 may include additional components. However, the EBC 222 does not include a sintering aid so as to avoid any damage to the TBC 221 due to the sintering aid remelting during use of the component 201. FIGS. 5 and 6 show enlarged views of the coating system 212 of FIG. 3 and illustrate a lack of glass phase sintering aid within the coating system 212.

In some examples, the layers 222, 220, 218, 216, and 214 of the coating system 212 may each have a dense microstructure, a columnar microstructure, or a combination of dense and columnar microstructures. A dense microstructure may be more effective in preventing the infiltration of environmental contaminants (e.g., steam), while a columnar microstructure may be more strain tolerant during thermal cycling. In various embodiments, a combination of dense and columnar microstructures may be more effective in preventing the infiltration of environmental contaminants than a fully columnar microstructure while being more strain tolerant during thermal cycling than a fully dense microstructure. In various embodiments, the dense microstructures may have a porosity of between about 5 to 10 percent and the columnar microstructures may have a porosity of about 5 to about 50 percent. In various embodiments, the layers 222, 220, 218, 216, and 214 have microstructures that transition from dense (e.g., layer 222) to columnar (e.g., 214). For example, the EBC 222 may have a porosity of about 10 percent, the first layer 220 may have a porosity of about 20 percent, the second layer 218 may have a porosity of about 30 percent, the third layer 216 may have a porosity of about 40 percent, and the fourth layer 214 may have a porosity of about 50 percent. Preferably, the porosity of the layers 222, 220, 218, 216, and 214 is closed.

The layers 222, 220, 218, 216, and 214 of the coating system 212 are not particularly limited in size, thickness, or other dimensions. In various embodiments, one or more of the layers 222, 220, 218, 216, and 214 of the coating system 212 may have a thickness of from about 0.5 to about 20 μm after sintering.

The coating system 212 may be applied onto the surface of the substrate 210 by various processes. In certain embodiments, the coating system 212 may be applied using a direct sintering process. For example, the coating system 212 may be applied using a spray application, dip application, silkscreen application, blade application, or a combination thereof. Each of the layers 222, 220, 218, 216, and 214 of the coating system 212 may be disposed on the substrate 210 as a paint, paste, or slurry, or as an aqueous or non-aqueous solution. In various embodiments, the slurries and/or pastes may include powders of a rare earth disilicate and/or a rare earth monosilicate mixed in a carrier fluid, such as alcohol. In some embodiments, the powders have submicron particles sizes, such as 0.02 to 20 μm.

After the one or more of the layers 222, 220, 218, 216, and/or 214 have been applied on/to the surface of the substrate 210, the applied layers may be dried. If the applied layers includes a binder, a debinding process may be performed to remove (e.g., burning off) all or a portion of the binder that is present in the applied layers. The drying process and the optional debinding process are not particularly limited relative to time, temperature, or pressure and these parameters may be chosen by one of skill in the art.

The substrate 210 may be placed into a furnace, an isostatic press (HIP) furnace, or other heating system having an inert gas (such as helium, neon, argon, krypton, xenon, or nitrogen) environment therein. A heat treatment and/or HIP process may be performed to apply heat and, optionally, pressure on the substrate 210. This may cause voids in the applied layers to collapse under the differential pressure and surfaces of the voids to diffusion bond together to effectively eliminate the defects therebetween.

A sintering process may be used to densify and/or crystallize the dried layers. In various embodiments, the sintering process is performed in a manner such that materials of the coating system 212 (e.g., ytterbium disilicate and/or ytterbium monosilicate) sinter in a solid state phase, that is, do not transition into a liquid state phase. By maintaining the solid state phase for an entirety of the sintering process, the coating system 212 may be produced having a microstructure with larger grains. For example, in various embodiments one or more of the layers 222, 220, 218, 216, and 214 of the coating system 212 may have a range of grain sizes of about 0.5 to 50 μm, such as about 1 to 20 μm.

FIG. 3 is a flow chart illustrating an exemplary method 300 for forming the coating system 212. The method 300 may start at 310. At 312, the method 300 may include providing the substrate 210. The step of providing the substrate 210 may include various processes of manufacturing the substrate 210 (e.g., casting, machining, etc.) and/or preparing the substrate 210 for forming the coating system 212 thereon (e.g., etching, cleaning, etc.). At 314, the method 300 includes applying and subsequently drying a first slurry or paste on the substrate 210. Optionally, debinding and/or HIP processes may be performed on the substrate 210 and the applied first slurry or paste. At 316, the method 300 includes sintering the first slurry or paste to densify and/or crystallize the first slurry or paste and thereby produce the EBC 222. In various embodiments, the EBC 222 may be substantially 100 wt. % ytterbium disilicate. In such embodiments, the sintering process may be performed at a temperature of greater than 1500° C., such as about 1500° C. to 1700° C., about 1550° C. to 1650° C., or about 1600° C.

Once the EBC 222 has been formed, the method 300 includes applying and subsequently drying one or more additional slurries or pastes on the EBC 22 at 318. For example, second, third, fourth, and fifth slurries and/or pastes may be sequentially applied to the EBC 222 and dried that are configured to produce the first, second, third, and fourth layers 220, 218, 216, and 214 of the TBC 221. Optionally, debinding and/or heating/HIP processes may be performed on the substrate 210 and the applied additional slurries or pastes. At 320, the method 300 includes performing a sintering process to densify and/or crystallize the applied additional slurries or pastes to form the TBC 221 (e.g., the first, second, third, and fourth layers 220, 218, 216, and 214). In various embodiments, the TBC 221 may include a composition gradient transitioning from the ytterbium disilicate to 100 wt. % ytterbium monosilicate. In such embodiments, the sintering process may be performed at a temperature of about 1500° C. or less, such as about 1400° C. to 1500° C., about 1450° C. to 1500° C., or about 1500° C. The method 300 may end at 322.

The components and methods disclosed herein provide various benefits over certain existing systems and methods. For example, components comprising the coating system 212 as described herein may be capable of operating at temperatures in excess of the thermal capabilities of a component comprising only an EBC. By producing the coating system 212 without inclusion of a sintering aid, the coating system 212 may exhibit improved performance and life span by avoiding damage caused by the remelting of such sintering aids. Further, by sintering the coating system 212 entirely in a solid state phase, the grains of the coating system 212 may be larger than grains produced by a sintering process that produces a liquid phase.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A component comprising:
a substrate comprising a ceramic material; and
a coating system on a surface of the substrate, wherein the coating system includes one or more layers defining a composition gradient, wherein a first portion of the coating system closest to the surface of the substrate has a first composition comprising at least 95 wt. % of a rare earth disilicate, a second portion of the coating system furthest from the surface of the substrate has a second composition comprising at least 50 wt. % of a rare earth monosilicate, and a third portion between the first portion and the second portion has a third composition comprising both the rare earth disilicate and the rare earth monosilicate.

2. The component of claim 1, wherein the first portion of the coating system is bonded directly to the surface of the substrate.

3. The component of claim 1, wherein the one or more layers have compositions consisting of the rare earth disilicate and/or the rare earth monosilicate.

4. The component of claim 1, wherein a first of the one or more layers defines the first portion of the coating system, a second of the one or more layers defines the second portion of the coating system, and at least a third of the one or more layers defines the third portion of the coating system.

5. The component of claim 1, wherein the coating system includes at least five layers, a first of the one or more layers having a first composition comprising at least 95 wt. % the rare earth disilicate, a second of the one or more layers having a second composition comprising about 20 to 30 wt. % of the rare earth monosilicate and about 70 to 80 wt. % of the rare earth disilicate, a third of the one or more layers having a third composition comprising about 45 to 55 wt. % of the rare earth monosilicate and about 45 to 55 wt. % of the rare earth disilicate, a fourth of the one or more layers having a fourth composition comprising about 70 to 80 wt. % of the rare earth monosilicate and about 20 to 30 wt. % of the rare earth disilicate, and a fifth of the one or more layers having a fifth composition comprising at least 95 wt. % of the rare earth monosilicate.

6. The component of claim 1, wherein the one or more layers of the coating system are formed without the use of a sintering aid.

7. The component of claim 1, wherein the one or more layers have grain sizes between 0.5 to 50 μm.

8. The component of claim 1, wherein the ceramic material of the substrate is silicon nitride, silicon carbide, silicon oxynitride, SiAlON materials, silicon dioxide, or combinations thereof.

9. The component of claim 1, wherein the rare earth disilicate is ytterbium disilicate and the rare earth monosilicate is ytterbium monosilicate.

10. The component of claim 1, where the component is configured to be installed in a turbine engine.

11. A method of producing a component having a coating system thereon, the method comprising:
providing a substrate comprising a ceramic material; and
forming one or more layers on a surface of the substrate to define the coating system, wherein the one or more layers define a composition gradient, wherein a first portion of the coating system closest to the surface of the substrate has a first composition comprising at least 95 wt. % of a rare earth disilicate, a second portion of the coating system furthest from the surface of the substrate has a second composition comprising at least 50 wt. % of a rare earth monosilicate, and a third portion between the first portion and the second portion has a third composition comprising both the rare earth disilicate and the rare earth monosilicate, wherein the coating system is formed without using a sintering aid.

12. The method of claim 11, wherein the one or more layers have compositions consisting of the rare earth disilicate and/or the rare earth monosilicate.

13. The method of claim 11, wherein forming the one or more layers is performed while maintaining solid state phases of the rare earth disilicate and the rare earth monosilicate.

14. The method of claim 11, wherein forming the one or more layers comprises:
applying one or more layers of one or more slurries or pastes to the surface of the substrate or a coating thereon; and
performing one or more direct sintering processes to densify and/or crystallize the one or more slurries or pastes to form the one or more layers that is bonded to the surface of the substrate of the coating system thereon.

15. The method of claim 14, further comprising preparing the one or more slurries to each comprise particulates of the rare earth monosilicate and/or the rare earth disilicate having a particle size with a maximum dimension of less than one micrometer.

16. The method of claim 11, wherein a first of the one or more layers defines the first portion of the coating system, a second of the one or more layers defines the second portion of the coating system, and at least a third of the one or more layers defines the third portion of the coating system.

17. The method of claim 11, wherein performing one or more direct sintering processes to densify and/or crystallize the one or more slurries or pastes includes heating the first portion at a first temperature of between 1550 and 1650° C. for a time sufficient to cause solid state sintering therein and heating the second portion and the third portion at a second temperature of between 1450 and 1500° C. for a time sufficient to cause solid state sintering therein.

18. The method of claim 11, wherein the coating system includes at least five layers, a first of the one or more layers having a first composition comprising at least 95 wt. % the rare earth disilicate, a second of the one or more layers having a second composition comprising about 20 to 30 wt. % of the rare earth monosilicate and about 70 to 80 wt. % of the rare earth disilicate, a third of the one or more layers having a third composition comprising about 45 to 55 wt. % of the rare earth monosilicate and about 45 to 55 wt. % of the rare earth disilicate, a fourth of the one or more layers having a fourth composition comprising about 70 to 80 wt. % of the rare earth monosilicate and about 20 to 30 wt. % of the rare earth disilicate, and a fifth of the one or more layers having a fifth composition comprising at least 95 wt. % of the rare earth monosilicate.

19. The method of claim 11, wherein forming the one or more layers includes controlling grain sizes within the one or more layers to produce a grain sizes between 0.5 and 50 μm.

20. The method of claim 11, wherein the ceramic material of the substrate is silicon nitride, silicon carbide, silicon oxynitride, SiAlON materials, silicon dioxide, or combinations thereof, and wherein the rare earth disilicate is ytterbium disilicate and the rare earth monosilicate is ytterbium monosilicate.
